(19) United States
(12) Patent Application Publication
(10) Pub. No.: US 2004/0256879 A1
(43) Pub. Date: Dec. 23, 2004

(54) Instrument panel and method of making same

(75) Inventors: Nadav Rave, Malvern, PA (US); Ismael Rodriguez, West Chester, PA (US); Roland Ewaniuk, Newtown Square, PA (US)

Correspondence Address: CAESAR, RIVISE, BERNSTEIN,, COHEN & POKOTILOW, LTD., 11TH FLOOR, SEVEN PENN CENTER, PHILADELPHIA, PA, 19103-2212, US

(73) Assignee: JSP LICENSES, INC., Wilmington, DE

(21) Appl. No.: 10/808,844

(22) Filed: Mar. 25, 2004

Related U.S. Application Data
(63) Continuation-in-part of application No. 10/600,552, filed on Jun. 20, 2003.

(51) Int. Cl. B62D 25/14

(52) U.S. Cl. 296/70

(57) ABSTRACT

A fragmentation-resistant instrument panel is provided which includes an outer layer having an inner surface and a core of expanded plastic foam of a predetermined shape. The core is secured to the inner surface of the outer layer. An inner layer is fixedly secured to the inner surface of the core to encapsulate the foam. A V-shaped groove in the core is provided where the groove has an open side open to the to the inner surface of the inner layer and a closed side adjacent to the inner surface of the outerlayer. The instrument panel will be resistant to fragmentation when an impact force is applied to the inner layer by the air bag and the V-shaped groove provides for a hinge point when the air bag is deployed such that the instrument panel directs the air bag toward a vehicle occupant. A method of manufacturing the instrument panel is also provided.

### CROSS-REFERENCE TO RELATED APPLICATION

This is a continuation-in-part application of U.S. application Ser. No. 10/600,552, entitled Fragmentation Resistant Instrument Panel and Method of Making Same, filed Jun. 20, 2003, now pending.

### BACKGROUND OF THE INVENTION

This invention relates generally to interior trim panels for motor vehicles, and, more particularly, to interior trim panels located adjacent to vehicle air bag assemblies.

Supplemental air restraint systems (SIRs) are well known for use in motor vehicles. Such SIRs typically include a driver air bag mounted on the steering wheel and a passenger air bag mounted on the instrument panel forward of the passenger seating position. SIRS may be located in other positions as well.

It is well known to mount the passenger air bag beneath the top surface of the instrument panel and to provide an air bag deployment opening within the padded instrument panel cover. The deployment opening in the instrument panel cover is closed by an air bag door which opens in response to air bag deployment to permit the air bag to deploy into the passenger compartment.

The present invention is directed generally to an instrument panel mounted air bag which may deploy into the passenger compartment without the provision of an opening in the instrument panel.

Conventional upper automotive instrument panels of this type are designed to facilitate the deployment of the SIR system. These panels are typically comprised of many layers of material including “foils” (the outer, exposed covering layer which is described in greater detail below), soft core materials, rigid substrate materials and reinforcing components. Many types of designs are in current use, but substantially all types must perform to industry and government standards and requirements. One such requirement is that during the deployment event, no fragmentation of materials used in panel construction may occur so as to violate the interior space of the vehicle and result in possible occupant injury.

For example, U.S. Pat. No. Re. 36,167 (Barnes), is directed to an air bag deployable instrument panel cover. Here, an air bag module is mounted on the instrument panel structure forwardly of the passenger seating position. An instrument panel cover is mounted atop the instrument panel to conceal the air bag from view. The instrument panel cover is fastened to the instrument panel structure by fasteners which include detachable fasteners provided in the portion of the instrument panel cover forward of the passenger to permit the air bag to lift the instrument panel cover upwardly away from the instrument panel structure upon air bag inflation. The forward edge (toward the front of the vehicle) of the instrument panel is fixed to the vehicle body structure. FIG. 4 depicts this prior art instrument panel.

Many materials, methods, and designs are currently in use on today's vehicles for such instrument panels. Generally, all of these incorporate conventional manufacturing materials and constructions. The use of these conventional technologies dictates that the product, in order to meet requirements, be of a highly structured, mass intensive, and costly design. The present invention substitutes an expanded polypropylene (EPP) base material for current materials and results in many advantages to the automotive manufacturer. EPP is well known and is a very low mass material resulting in gross vehicle weight reduction and prime material savings. The incorporation of the design of the present invention assures the reliability of the product and its ability to pass performance requirements. With performance criteria met, a lower price, lower mass, higher quality product is available.

The construction of an instrument panel, as referred to herein, uses EPP as a core material which is backmolded behind an appearance foil in a steam chest process. However, it is possible that, upon deployment of the SIR, the EPP core material may, in some cases, fracture causing separation of loose particles which violate the interior space of a motor vehicle. The present invention provides a solution to this problem.

Another potential problem with the deployable instrument panel cover as disclosed, for example, in Barnes (above) is that the air bag is directed primarily in an upward direction since the opening formed when the instrument panel cover is pushed opened by the air bag is generally facing in an upward direction toward the front window of the vehicle. It would be beneficial for the air bag to be directed toward the passenger rather than toward the front window.

All references cited herein are incorporated herein by reference in their entireties.

### BRIEF SUMMARY OF THE INVENTION

A fragmentation-resistant instrument panel for use in a vehicle having an air bag is provided which includes an outer layer having an inner surface and a core of expanded plastic foam of a predetermined shape and having an inner surface. The core is secured to the inner surface of the outer layer. An inner layer having an inner surface is provided that is fixedly secured to the inner surface of the core to at least partially encapsulate the expanded plastic foam between it and the outer layer. An inverted, generally V-shaped groove is provided in the core of expanded plastic. The V-shaped groove has an open side open to the inner surface of the inner layer and a closed side adjacent to the inner surface of the outerlayer. The instrument panel will be resistant to fragmentation in the event that an impact force is applied to the inner layer and the V-shaped groove provides for a hinge point when the air bag is deployed directing the air bag toward an occupant.

Preferably, the expanded plastic foam is a plurality of small polypropylene beads that are joined to one another when heat is applied.

Optionally, the outer layer includes a material such as a textile, thermoplastic polyolefin or polyvinylchloride.

The expandable air bag forming a portion of a supplemental restraint system is preferably mounted adjacent the inner layer.

The inner layer may be a thermoplastic film material and may be reinforced with one or more textiles.

A method of manufacturing a fragmentation-resistant instrument panel for use in a vehicle having a air bag is also provided, which includes the steps of providing an outer layer having an inner surface, molding plastic beads into an expanded plastic foam core of a predetermined shape and having an inner surface, securing the core of expanded plastic foam to the inner surface of the outer layer, and fixedly securing an inner layer of material onto the inner surface of the core to at least partially encapsulate the expanded plastic foam between it and the outer layer. The predetermined shape includes an inverted, generally V-shaped groove in the core, where the V-shaped groove has an open side open to the inner surface of the inner layer and a closed side adjacent to the inner surface of the outerlayer. The instrument panel will be resistant to fragmentation in the event that an impact force is applied to the inner layer and the V-shaped groove provides for a hinge point when the air bag is deployed such that the instrument panel directs the air bag toward a vehicle occupant.

Preferably, the step of molding a plurality of plastic beads into an expanded plastic foam includes molding a plurality of small polypropylene beads that are joined to one another by the application of heat thereto. The steps of molding a plurality of plastic beads into an expanded plastic foam core and securing the core of expanded plastic foam to the inner surface of the outer layer preferably occur in a single step using a steam chest molding process. The step of providing the outer layer preferably includes providing a textile, thermoplastic polyolefin or polyvinylchloride.

The instrument panel and method of manufacturing the instrument panel of the present invention may also be provided without an inner layer having an inner surface that is fixedly secured to the inner surface of the core. In this case, the expanded plastic foam will not be encapsulated between it and the outer layer. Therefore, the benefit of the excellent fragmentation resistance will be reduced.

### BRIEF DESCRIPTION OF SEVERAL VIEWS OF THE DRAWINGS

The invention will be described in conjunction with the following drawings in which like reference numerals designate like elements throughout the several views and wherein:

FIG. 1 is a front isometric view of a fragmentation resistant instrument panel in accordance with one preferred embodiment of the present invention, showing the foil side of the instrument panel;

FIG. 2 is a rear isometric view of the fragmentation resistant instrument panel of FIG. 1;

FIG. 3 is a cross-sectional view of the fragmentation-resistant instrument panel of FIG. 1, taken substantially along line 3-3 of FIG. 1;

FIG. 4 is an isometric view of an example of a prior art instrument panel of the general type of the preferred embodiment of the present invention;

FIG. 5 is a rear isometric view of a fragmentation resistant instrument panel in accordance with a second preferred embodiment of the present invention;

FIG. 6 is a front isometric view of the fragmentation resistant instrument panel of FIG. 5;

FIG. 7 is a partial, cross-sectional view of the fragmentation resistant instrument panel of FIG. 5, take substantially along lines 7-7 of FIG. 6, depicted prior to deployment of a vehicle air bag;

FIG. 8 is a front isometric view of the fragmentation resistant instrument panel of FIG. 5, depicted subsequent to the deployment of a vehicle air bag; and

FIG. 9 is a partial, cross-sectional view of the fragmentation resistant instrument panel of FIG. 5, take substantially along lines 7-7 of FIG. 6, depicted subsequent to deployment of a vehicle air bag.

### DETAILED DESCRIPTION OF THE INVENTION

In accordance with the present invention, a reliable solution to problems associated with fragmentation of an instrument panel upon deployment of an air bag is provided which incorporates a film layer that is adhered to at least part of the back side of the instrument panel. This film layer would serve to at least partially encapsulate and contain fragmented particles during SIR deployment by entrapping the fragmented particles between the outer foil and the film layer on the back side of the instrument panel. The film layer also serves to further strengthen the composite and to eliminate or reduce fractures.

Additionally, a novel air bag guiding feature in the form of a V-shaped groove is also provided to assist in guiding a vehicle air bag toward a vehicle occupant, rather than in an upward direction toward the vehicle's windshield.

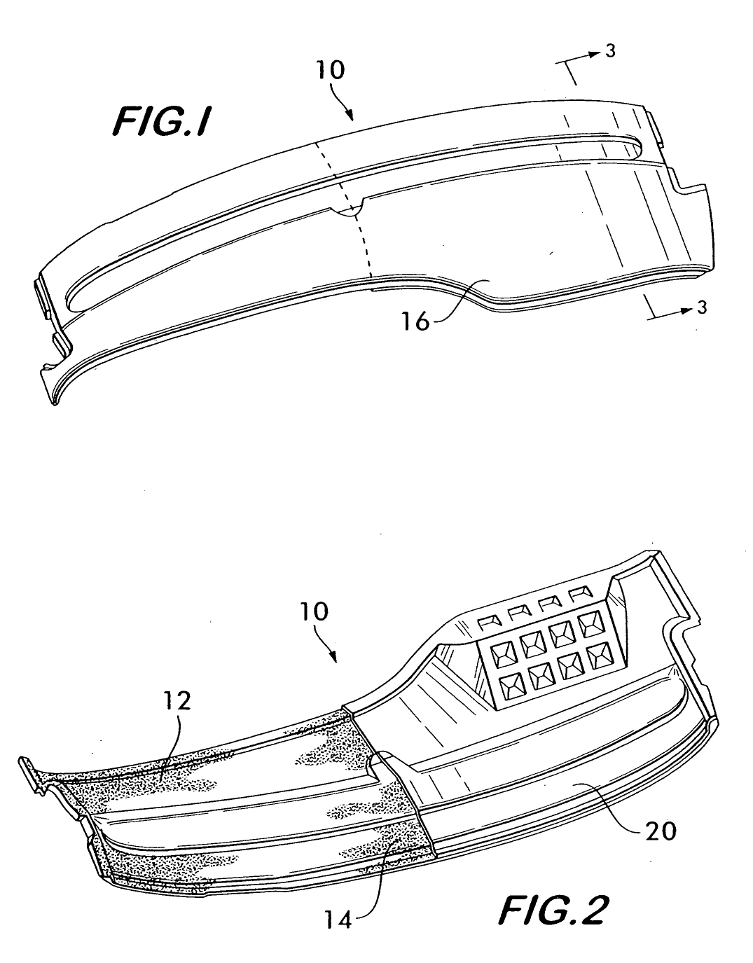

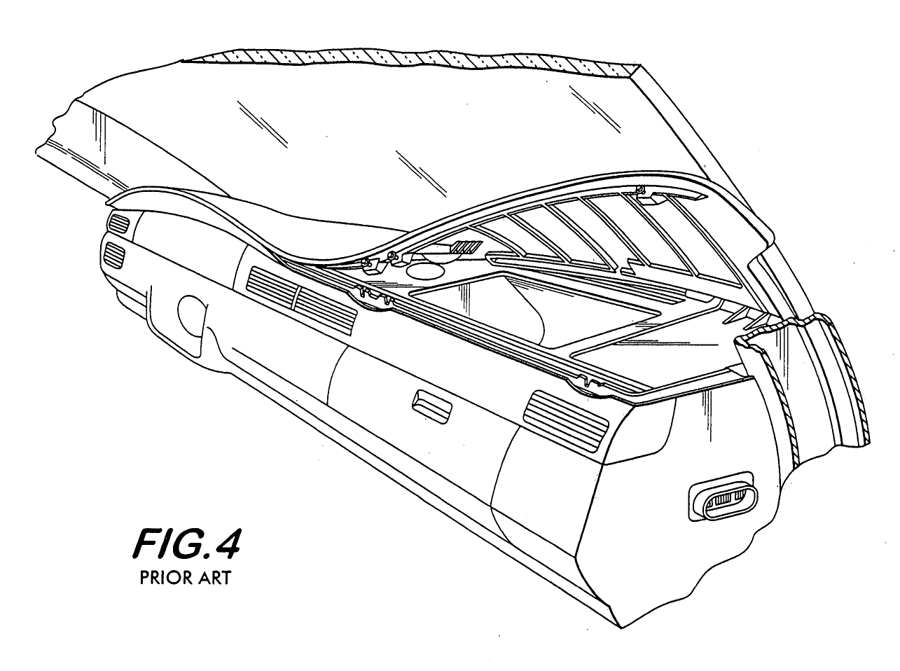

Referring now to the drawings, wherein like part numbers refer to like elements throughout the several views, there is shown in FIGS. 1 and 2 a fragmentation resistant instrument panel 10 for use in a vehicle in accordance with one preferred embodiment of the present invention. The instrument panel generally is of a type as shown, for example, in U.S. Pat. No. Re. 36,167 which is fully incorporated herein by reference. FIG. 4 shows such an instrument panel. However, the present invention is intended to be used with numerous other types of instrument panels.

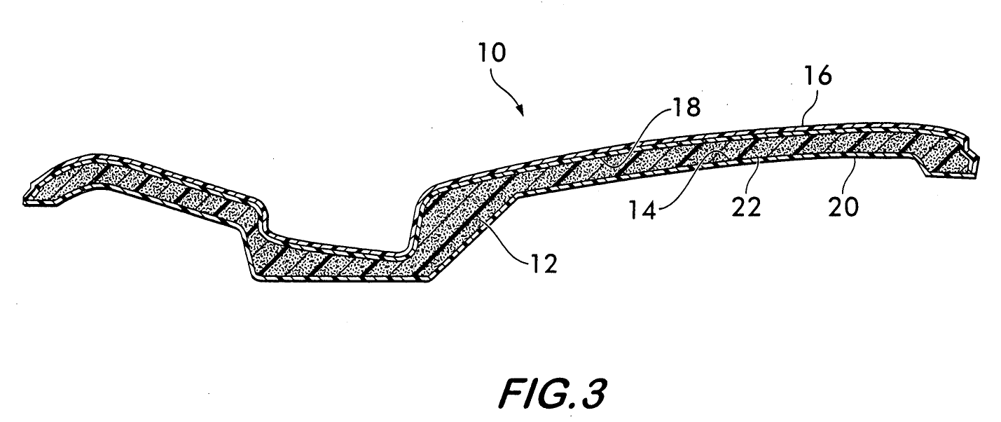

As can be seen in FIGS. 1-3, the instrument panel 10 includes a core 12 constructed of, for example, expanded plastic. The core 12 is fabricated in mold in a predetermined shape suitable for use as an instrument panel 10. The core 12 has an inner surface 14. The instrument panel 10 further includes a foil (outer layer 16) which has an inner surface 18. The core 12 is secured to the inner surface 18 of the outer layer 16. A film layer (inner layer 20) having an inner surface 22 is fixedly secured to the inner surface 14 of the core 12 to at least partially encapsulate the expanded plastic foam of the core 12 between the inner layer 20 and the outer layer 16.

The present invention preferably applies to an upper instrument panel cover panel.

However, other uses where fragmentation is to be avoided are intended to be included within the scope of the present invention. The construction of the preferred instrument panel 10 includes a “foil” cover material (i.e., the outer layer 16), an EPP foam core 12 and a backside material or film (i.e., the inner layer 20). The product is preferably manufactured using steam chest molding technology, as is well known. Generally, in a steam chest molding process, articles such as foamed boards or sheets are molded from expanded foam material, such as polystyrene. A cavity is filled with beads of the partially expanded polystyrene and steam is used to completely expand the beads. The foam is then cooled with water. Preferably, the core, 12, the outer layer 16 and the inner layer 20 are steam chest molded in a single step, as known.

The foil (outer layer 16) on the visible surface can be a textile, a thermoplastic polyolefin (TPO), or a polyvinyl chloride (PVC) or similar material known in the art. For purposes of the present invention, a “textile” is a flexible material, whether knitted or woven, or in the form of mesh or netting, consisting of natural or synthetic fibers, including, without limitation, cotton, wool, silk, rayon, nylon, orlon, polyester, polypropylene, polyethylene, and the like. The outer layer 16 may have multiple layers. For example, outer layer 16 may have a backing material such as crosslinked polypropylene (XLPP), crosslinked polyethylene (XLPE), polyurethane (PU), thermoplastic polyolefin (TPO), or polypropylene (PP) bonded to them prior to being backmolded with expanded polypropylene (EPP). That is, the outer layer 16 may be, for example, a single layer, a bilaminate, a trilaminate, or the like, as well known in the art.

The outer layer 16 may be applied in the steam chest molding operation by introducing the film sheeting into the mold space onto the core half of the mold during machine cycle and using the heated environment of the core chamber to fusion bond the outer layer 16. The outer layer 16 may otherwise be applied to the backside as a post molding operation using conventional heat bonding equipment and tooling such as sonic welding, heated air, or vibration welding.

The film material applied to the underside of the panel (i.e., the inner layer 20) may be a thermoplastic film material. Optionally, this film may be reinforced with one or more textiles. This material may be assembled as a one step process in the steam chest molding process or as a post molding operation using, for example, a heat bonding process. The resin film material applied to the backside of the panel serves to create an envelope which, when coupled with the foil (outer layer 20) on the visible side of the instrument panel 10, serves to at least partially encapsulate the EPP core material (of core 12). This encapsulation feature serves to contain any loose or fractured fragments of EPP core material which may separate from parent material during the deployment of the vehicle's SIR system and thus perform as required. The resin film may be applied in the one step steam chest molding operation by introducing the film sheeting into the mold space onto the core half of the mold during machine cycle and using the heated environment of the core chamber to fusion bond the film. The film (inner layer 20) may otherwise be applied to the backside as a post molding operation using conventional heat bonding equipment and tooling such as sonic welding, heated air, or vibration welding.

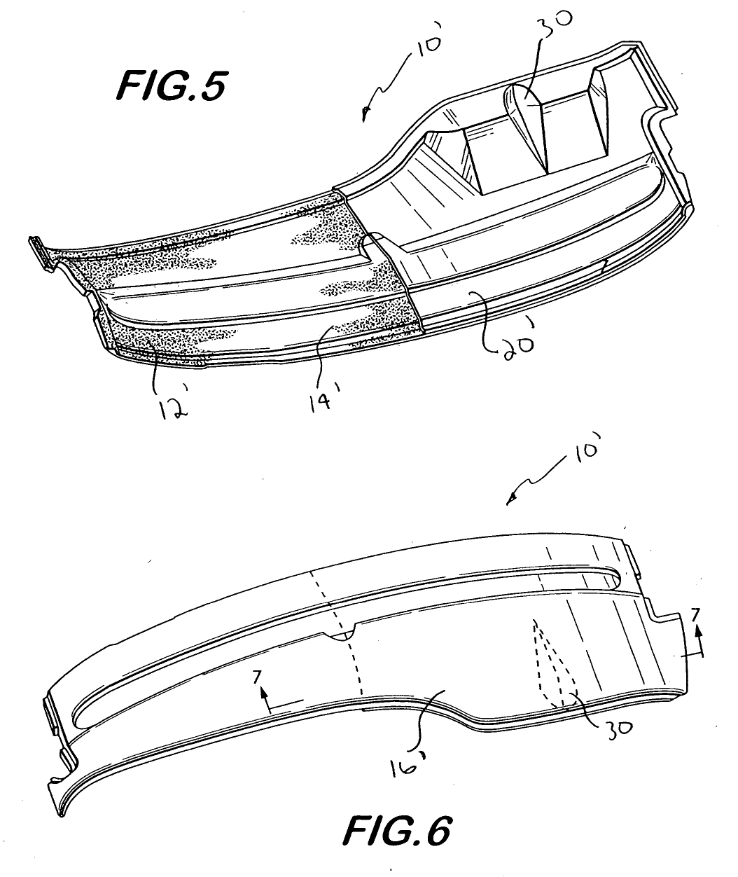

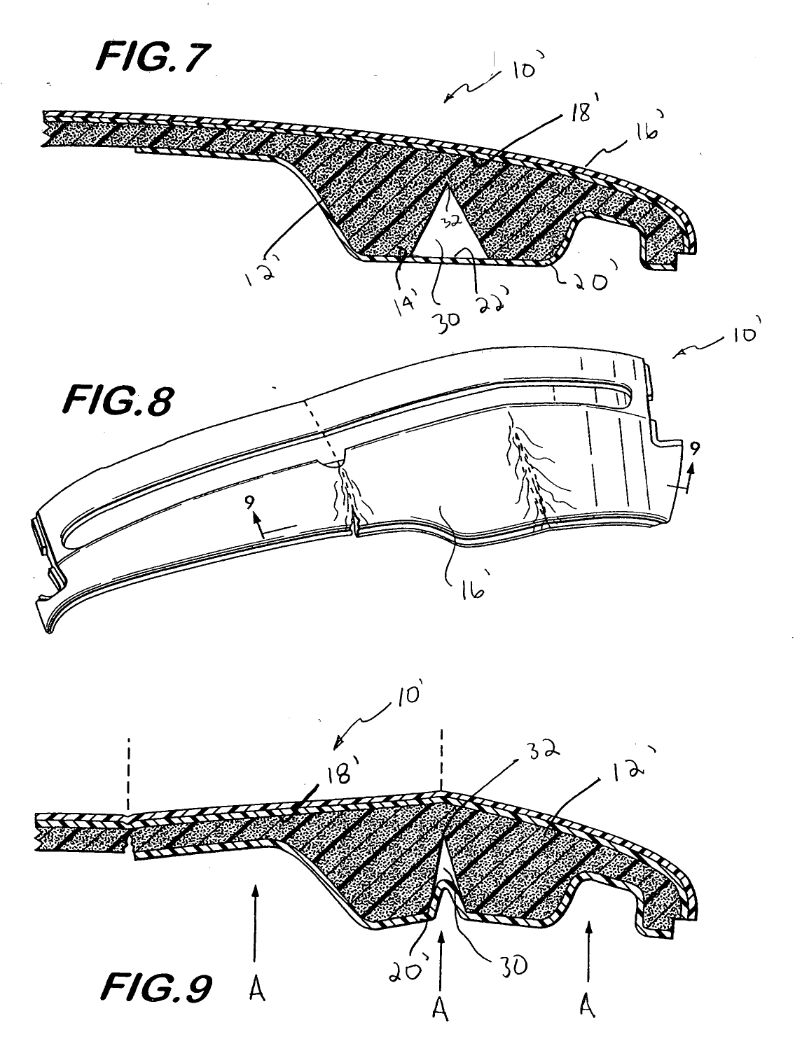

Optionally, as shown in the alternate embodiment of a fragmentation resistant instrument panel 10′ of FIGS. 5-9, there is shown an inverted, V-shaped groove 30 in the core 12′. As is similar to the embodiment of FIGS. 1-3 and 5-6, the instrument panel 10′ includes a core 12′, an inner surface 14′, an outer layer (foil) 16′, an inner surface 18′ of the outer layer 16′, and film layer (inner layer 20′) having an inner surface 22′. The V-shaped groove 30 serves to create a weakened area in the instrument panel 10′ at a point 32 at the apex of the V-shaped groove 30 such that an air bag is directed toward a vehicle occupant seated on the front seat of the vehicle adjacent to the instrument panel. The V-shaped groove 30 causes the instrument panel 10′ to fold at the V-shaped groove 30 (as shown comparing FIG. 7 to FIG. 9) when hit by the air bag (in direction A) causing the air bag to inflate and be directed toward the occupant. The sides of the V-shaped groove close inwardly towards one another. If the V-shaped groove is not provided, the air bag may be directed in an upwardly direction towards the windshield of the vehicle, rather than towards the occupant. The EPP of the core 12′ may fracture above the V-shaped groove 30, but the outer layer 16′ should not fracture. The outer skin 12 may fracture at other locations, for example, where the instrument panel 10′ attaches to vehicle. See FIGS. 8 and 9.

FIGS. 5-9 depict an instrument panel having an inner layer 22′ to provide for fragmentation resistance as described in detail above. However, the V-shaped groove may be provided in the core of instrument panel that does not have an inner layer 22′. The benefits of the V-shaped groove 30 are still possible whether or not the inner layer 22′ is provided.

While the V-shaped groove 30 is shown as a V-shape, the terms “V-shaped” and “generally V-shaped,” as provided in the present invention, are intended to include other similar shapes that would function in a similar manner. For example, the V-shaped groove could have a rounded apex or could even have parallel sides connected by, for example, an arc, thereby making the shape that of a “U.” Other shapes, including asymmetric shapes to help guide the air bag appropriately are also intended to be included in the definition of “V-shape” of the present application.

While the invention has been described in detail and with reference to specific embodiments discussed herein, it will be apparent to one skilled in the art that various changes and modifications can be made therein without departing from the spirit and scope thereof.

What is claimed is:

1. A fragmentation-resistant instrument panel for use in a vehicle having an air bag, comprising:
(a) an outer layer having an inner surface;
(b) a core of expanded plastic foam of a predetermined shape and having an inner surface, said core secured to the inner surface of the outer layer;
(c) an inner layer having an inner surface fixedly secured to the inner surface of said core to thereby at least partially encapsulate said expanded plastic foam between the inner layer and said outer layer; and
(d) an inverted, generally V-shaped groove in the core of expanded plastic, said V-shaped groove having an open side open to the to the inner surface of the inner layer and a closed side adjacent to the inner surface of the outerlayer;
whereby said instrument panel will be resistant to fragmentation in the event that an impact force is applied to said inner layer and the V-shaped groove provides for a hinge point when the air bag is deployed such that the instrument panel directs the air bag toward a vehicle occupant.

2. The fragmentation-resistant instrument panel of claim 1 wherein said expanded plastic foam comprises a plurality of small polypropylene beads that are joined to one another by the application of heat thereto.

3. The fragmentation-resistant instrument panel of claim 1, wherein said outer layer comprises a material selected from the group consisting of textiles, thermoplastic polyolefins and polyvinylchloride.

4. The fragmentation-resistant instrument panel of claim 2, wherein said outer layer comprises a material selected from the group consisting of textiles, thermoplastic polyolefins and polyvinylchloride.

5. The fragmentation-resistant instrument panel of claim 1, additionally comprising an expandable air bag forming a portion of a supplemental restraint system mounted adjacent said inner layer.

6. The fragmentation-resistant instrument panel of claim 1, wherein the inner layer is a thermoplastic film material.

7. The fragmentation-resistant instrument panel of claim 1, wherein the inner layer is reinforced with one or more textiles.

8. A method of manufacturing a fragmentation-resistant instrument panel for use in a vehicle having an air bag, comprising the steps of:
(a) providing an outer layer having an inner surface;
(b) molding a plurality of plastic beads into an expanded plastic foam core of a predetermined shape and having an inner surface;
(c) securing the core of expanded plastic foam to the inner surface of the outer layer; and
(d) fixedly securing an inner layer of material onto the inner surface of the core, to thereby at least partially encapsulate the expanded plastic foam between it and the outer layer;
(e) said predetermined shape including an inverted, generally V-shaped groove in the core, said V-shaped groove having an open side open to the inner surface of the inner layer and a closed side adjacent to the inner surface of the outerlayer;
whereby the instrument panel will be resistant to fragmentation in the event that an impact force is applied to the inner layer and the V-shaped groove provides for a hinge point when the air bag is deployed such that the instrument panel directs the air bag toward a vehicle occupant.

9. The method of claim 8, wherein the step of molding a plurality of plastic beads into an expanded plastic foam comprises molding a plurality of small polypropylene beads that are joined to one another by the application of heat thereto.

10. The method of claim 8, wherein the steps of molding a plurality of plastic beads into an expanded plastic foam core and securing the core of expanded plastic foam to the inner surface of the outer layer occur in a single step using a steam chest molding process.

11. The method of claim 8, wherein the step of providing the outer layer comprises providing a material selected from the group consisting of textiles, thermoplastic polyolefins and polyvinylchloride.

12. An instrument panel for use in a vehicle having an air bag, comprising:
(a) an outer layer having an inner surface;
(b) a core of expanded plastic of a predetermined shape and having an inner surface, said core secured to said inner surface of said outer layer; and
(c) said predetermined shape including an inverted, generally V-shaped groove in the core of expanded plastic, said V-shaped groove having an open side and a closed side, said closed side adjacent to the inner surface of the outer layer;
whereby said inner layer and the V-shaped groove provides for a hinge point when the air bag is deployed such that the instrument panel directs the air bag toward a vehicle occupant.

13. The method of claim 12, wherein the step of molding a plurality of plastic beads into an expanded plastic foam comprises molding a plurality of small polypropylene beads that are joined to one another by the application of heat thereto.

14. The method of claim 12, wherein the steps of molding a plurality of plastic beads into an expanded plastic foam core and securing the core of expanded plastic foam to the inner surface of the outer layer occur in a single step using a steam chest molding process.

15. The method of claim 12, wherein the step of providing the outer layer comprises providing a material selected from the group consisting of textiles, thermoplastic polyolefins and polyvinylchloride.

16. A method of manufacturing an instrument panel for use in a vehicle having an air bag, comprising the steps of:
(a) providing an outer layer having an inner surface;
(b) molding a plurality of plastic beads into an expanded plastic foam core of a predetermined shape and having an inner surface;
(c) securing the core of expanded plastic foam to the inner surface of the outer layer; and
(e) said predetermined shape including an inverted, generally V-shaped groove in the core of expanded plastic, said V-shaped groove having an open side and a closed side adjacent to the inner surface of the outerlayer;
whereby the V-shaped groove provides for a hinge point when the air bag is deployed such that the instrument panel directs the air bag toward a vehicle occupant.

17. The method of claim 16, wherein the step of molding a plurality of plastic beads into an expanded plastic foam comprises molding a plurality of small polypropylene beads that are joined to one another by the application of heat thereto.

18. The method of claim 16, wherein the steps of molding a plurality of plastic beads into an expanded plastic foam core and securing the core of expanded plastic foam to the inner surface of the outer layer occur in a single step using a steam chest molding process.

19. The method of claim 16, wherein the step of providing the outer layer comprises providing a material selected from the group consisting of textiles, thermoplastic polyolefins and polyvinylchloride.
